(19) United States
(12) Patent Application Publication
(10) Pub. No.: US 2021/0241401 A1
(43) Pub. Date: Aug. 5, 2021

(54) SYSTEM AND METHOD FOR INTELLECTUAL PROPERTY RIGHTS LABELING

(71) Applicant: THE BOEING COMPANY, Chicago, IL (US)

(72) Inventors: Duane J. McCollum, Seattle, WA (US); Michael A. Snow, Williamsburg, VA (US)

(73) Assignee: The Boeing Company

(21) Appl. No.: 16/778,044

(22) Filed: Jan. 31, 2020

(51) Int. Cl. G06Q 50/18; G06N 20/00; G06F 30/15; G06Q 10/06

(52) U.S. Cl. CPC G06Q 50/184; G06N 20/00; G06Q 10/0875; G06Q 10/0635; G06F 30/15

(57) ABSTRACT

A method includes accessing, by a processor of a computing device, metadata of a data file associated with a mixed-IP rights project. The method also includes performing, by the processor, a comparison of values of metadata field(s) of the metadata to a rights criterion. The method further includes, based on whether the comparison indicates that values of the one or more metadata fields satisfy the rights criterion, storing data indicating assignment of an IP rights label of a set of candidate IP rights labels to the data file.

This invention was made with Government support under contract number N00019-14-C-0067 awarded by the U.S. Department of Navy. The government may have certain rights in this invention.

### FIELD OF THE DISCLOSURE

The subject disclosure is related to labeling of intellectual property rights.

### BACKGROUND

When two or more parties (e.g., companies, governmental organizations, or individuals) enter into a contractual relationship, questions can arise as to the intellectual property rights of each of the parties for inventions, documents, software code, or other intellectual property that is generated under the contractual relationship. Well considered contracts may define how rights in the intellectual property are to be allocated, such as which party will own the intellectual property, which party will have a license to use, sell, or make the intellectual property, etc. However, even when clear contract terms are present, complicated rights issues can arise. To illustrate, often a first party hires or contracts with a second party because the second party has some pre-existing expertise in a particular field, and the contract is to use that pre-existing expertise in a manner that assists the first party. To the extent that any new invention comes from interaction of the parties in this situation, the first party or the first and second party may own rights to the new invention. However, the new invention may be a variant of an invention that either the first party or the second party owns exclusively. Thus, some aspects of the new invention are owned exclusively by one party while other aspects are co-owned or owned by the other party. For complex and/or highly integrated systems, it can be very time consuming and costly to distinguish intellectual property rights in such situations.

### SUMMARY

According to a particular aspect, a method includes accessing, by a processor of a computing device, metadata of a data file associated with a mixed-intellectual property (IP) rights project. The method also includes performing, by the processor, a comparison of values of metadata field(s) of the metadata to a rights criterion. The method further includes, based on whether the comparison indicates that values of the one or more metadata fields satisfy the rights criterion, storing data indicating assignment of an IP rights label of a set of candidate IP rights labels to the data file.

According to another aspect, a system includes one or more processors and one or more memory devices. The memory device(s) store instructions that are executable by the processor(s) to perform operations including accessing, by an IP rights classifier, metadata of an engineering design or analysis data file associated with a blended-IP rights project. The operations also include selecting, by the IP rights classifier based on the metadata, an IP rights label of a set of candidate IP rights labels to assign to the engineering design or analysis data file. The operations further include storing, at the memory device(s), data indicating assignment of the IP rights label to the engineering design or analysis data file.

According to a further aspect, a computer-readable storage device stores instructions that are executable by one or more processors to perform operations including accessing a data file associated with design or analysis of an engineering project in which multiple entities potentially have IP rights. The operations also include evaluating metadata field(s) of metadata of the data file based on rights selection criteria and selecting, based on the rights selection criteria, an IP rights label of a set of candidate IP rights labels to be assigned to the data file. The operations further include storing data indicating assignment of the IP rights label to the data file.

### BRIEF DESCRIPTION OF THE DRAWINGS

FIG. 1 is a block diagram illustrating a system for labeling intellectual property rights according to a particular aspect.

FIG. 2 is a flow chart illustrating an example of a method for assigning an intellectual property rights label.

FIG. 3 is a flow chart illustrating another example of a method for assigning an intellectual property rights label.

FIG. 4 is a flow chart illustrating another example of a method for determining risk values associated with assignment of an intellectual property rights label.

FIG. 5 is a block diagram illustrating a computing environment in accordance with a particular implementation.

### DETAILED DESCRIPTION

Aspects disclosed herein present systems and methods for assigning intellectual property (IP) rights labels. In complex projects, a large number of design documents can be generated. When a complex project is undertaken by multiple parties under the terms of a contract, it is important to determine the IP rights of each party in the content of each of these design documents. Additionally, other types of IP can be generated, such as software code, and it is also important to determine the IP rights of each party in these other types of IP. It can be difficult to properly identify each party's IP rights, at least in part, to the volume of data (e.g., documents, code, etc.) produced. The subject disclosure describes systems and methods to facilitate labeling data files with labels indicating IP rights associated with the data files. One technical effect of the disclosed systems and methods for assigning IP rights labels is improved data access control. For example, a party's access to particular data files can be tied, at least in part, to the party's underlying IP rights in the content of the data files. Thus, properly labeling the data files with IP rights labels improves data access control and security. Additional technical benefits include reducing the computing time and resources used to comply with contractual obligations. For example, U.S. Government contracts often include a requirement to allow government officials access to certain documents or data files generated under the terms of the contracts. However, it can be time consuming and resource intensive for a large government contractor to sort through a large number of data files to determine whether each was generated under the terms of the contract and therefore should be made accessible.

As one example, when a government purchases a new aircraft platform, it is not uncommon for the government to contract with an existing aircraft manufacturer to produce an aircraft platform that has specified characteristics. In such situations, where possible, the aircraft manufacturer may start with an aircraft design for an aircraft that is already in production and modify the pre-existing aircraft design to accommodate the government's specified characteristics. The process of modifying the pre-existing aircraft design can take a significant amount of time, and during this time the aircraft manufacturer may modify the pre-existing aircraft design for other reasons (e.g., to improve fuel efficiency or to simplify a manufacturing process). In this situation, even though the modification to the pre-existing aircraft design took place while the government contract was in effect, the modification to the pre-existing aircraft design was not made under the terms of the government contract. However, if design documents associated with the modification to the pre-existing aircraft design are not properly labeled, significant time and resources can be expended trying to determine whether the government has IP rights in the modification to the pre-existing aircraft design. Similar issues can arise in contexts other than aircraft manufacturing.

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

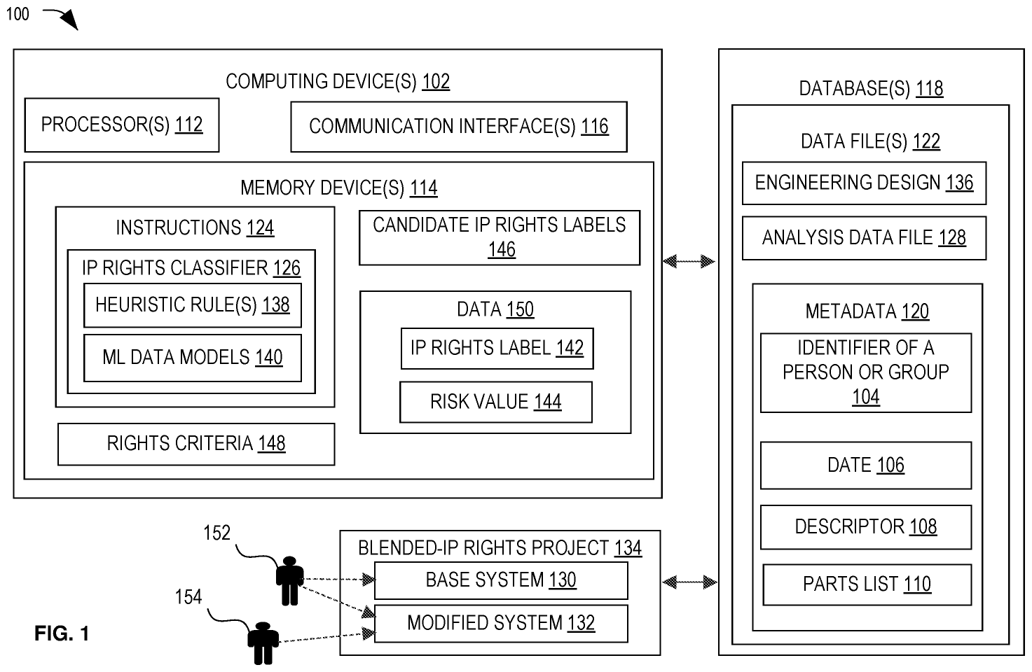

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a system 100 including one or more computing devices 102, which indicates that in some implementations the system 100 includes a single computing device and in other implementations the system 100 includes multiple computing devices.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating”, “calculating”, “using”, “selecting”, “accessing”, and “determining” are interchangeable unless context indicates otherwise. For example, “generating”, “calculating”, or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

FIG. 1 is a block diagram illustrating a system 100 for labeling IP rights according to a particular aspect. The system 100 includes one or more computing devices 102 and one or more databases 118 associated with a blended-IP rights project 134. In this context, a blended-IP rights project (also referred to herein as a mixed-IP rights project) is a project in which two or more parties (e.g., two or more companies, government organizations, or individuals) are participating or funding, and each of the parties may have some IP rights in the project or results of the project. The blended-IP rights project 134 is generally formed as a result of a contractual relationship between parties, although a blended-IP rights project 134 can arise due to other circumstances, such as combined effort that is not under the terms of a contract.

The example of FIG. 1 illustrates a particular situation in which a blended-IP rights project 134 can arise. In FIG. 1, a first entity 152 owns IP rights in a base system 130 (e.g., due to prior development or design of the base system 130), and the first entity 152 and a second entity 154 enter into a contractual relationship to develop a modified system 132, which is a modified version of the base system 130. To illustrate, the base system 130 may correspond to a commercial aircraft (and/or other land, sea, space vehicle) designed and/or manufactured by the first entity 152, and the modified system 132 may corresponds to a military platform based on the commercial aircraft and developed under a contact with the second entity 154. In this illustrative example, the modified system 132 is designed by adapting at least a portion of the base system 130. For purposes of this example, the first entity 152 owns all IP rights in the base system 130 and some IP rights in the modified system 132; whereas, the second entity 154 at most has some IP rights in the modified system 132. Note that in other circumstances, the situation can be even more complicated. For example, the base system 130 itself can be the result of another blended-IP rights project between the first entity 152 and another entity (not shown). In this situation, the first entity 152 and the other entity may both have IP rights in the base system 130. Accordingly, it can be important to accurately account for which entity or entities have IP rights to each aspect of the blended-IP rights project 134.

The database(s) 118 store data related to the blended-IP rights project 134 as one or more data files 122. The data file(s) 122 include information related to or describing an engineering design 136, an analysis data file 128, or other engineering or manufacturing data files. Additionally, the data file(s) 122 include or are associated with metadata 120. The metadata 120 for a particular data file includes a plurality of data fields, such as an identifier 104 of a person or group responsible for the data file, a date 106 of generation or release of the data file, a descriptor 108 of the data file, a parts list 110 of parts associated with the data file, etc. In a particular example, the data file(s) 122 include engineering drawings, analysis data, software code, engineering design calculations, etc. In some implementations, various fields of the metadata 120 are stored in different location, such as in different data tables, in which case the metadata 120 represents a union or join operation or another table manipulation operation to aggregate the metadata 120 for analysis.

The computing device(s) 102 include one or more processors 112, one or more communication interfaces 116, and one or more memory devices 114. The memory device(s) 114 and the communication interface(s) 116 are coupled to the processor(s) 112 to enable the processor(s) 112 to access data and instructions 124 from the memory device(s) 114 and the data file(s) 122 from the database(s) 118. In some implementations, the database(s) 118 can be stored in whole or in part in the memory device(s) 114.

The instructions 124 are executable by the processor(s) 112 to assign IP rights labels to the data file(s) 122. In the example of FIG. 1, the instructions 124 include an IP rights classifier 126 that is configured to generate data 150 indicating assignment of a particular IP rights label to a particular data file. The IP rights classifier 126 includes one or more heuristic rules 138, one or more machine learning (ML) models 140, or both. In particular implementations, the IP rights classifier 126 compares one or more values of fields of the metadata 120 to rights criteria 148 to determine which of the first entity 152 and the second entity 154 has IP rights in a particular data file based on whether the one or more values satisfy a rights criterion of the rights criteria 148. For example, in some implementations, the rights criterion is satisfied when the one or more values of the metadata 120 indicate that the data file pertains to the base system 130 without modification. In this example, when the rights criterion is satisfied, the data 150 indicate single-party IP rights associated with the first entity 152. On the other hand, when the rights criterion is not satisfied in this example, the data 150 indicate multi-party IP rights associated with the first entity 152 and the second entity 154 or indicate single-party IP rights associated with the second entity 154.

The metadata 120 accessed by the IP rights classifier 126 is indicative of whether a particular data file pertains to the base system 130 without modifications associated with the mixed-IP rights project. For example, a first engineering group or department may be associated with the base system 130 and a second engineering group or department may be associated with the modified system 132. In this example, the identifier 104 indicates a person or group that generated or released the data file. Thus, if the identifier 104 indicates that a person from the first engineering group released the data file, the IP rights classifier 126 may determine that the data file is associated with the base system 130 without modification. As another example, the base system 130 may be associated with data file(s) 122 that predate the blended-IP rights project 134. In this example, the IP rights classifier 126 can assign an IP rights label 142 indicating single-party IP rights associated with the first entity 152 if the date 106 indicates that the data file was generated or released before instantiation of the blended-IP rights project 134. In another example, the base system 130 can use a particular part or assembly that is not used by the modified system 132, or vice versa, to determine IP rights labels. In this example, the IP rights classifier 126 can assign an IP rights label 142 indicating single-party IP rights associated with the first entity 152 or the second entity 154 or multi-party rights associated with both entities 152, 154 depending on whether the parts list 110 lists the particular part or assembly. As yet a further example, the descriptor 108 can include a code, a name, or another designator that distinguishes data files associated with the base system 130 from data files associated with the modified system 132.

In some implementations, the IP rights classifier 126 uses a hierarchical or tiered process to determine an IP rights label to assign to a particular data file. For example, if a first comparison indicates that a value of a first metadata field fails to satisfy a corresponding first rights criterion, the IP rights classifier 126 performs a second comparison of a value of a second metadata field to a second rights criterion. In this example, the IP rights classifier 126 assigns a second IP rights label to the data file if the second comparison indicates that the second rights criterion is satisfied, and if the second rights criterion is not satisfied, the IP rights classifier 126 performs a third comparison of a value of a third metadata field to a third rights criterion. The IP rights classifier 126 assigns a third IP rights label to the data file if the third comparison indicates that the third rights criterion is satisfied, and if the third rights criterion is not satisfied, the IP rights classifier 126 assigns a fourth IP rights label or performs one or more additional comparisons. Although three tiers (corresponding to the three comparisons) are described in this example, in other examples, more or fewer tiers (and corresponding comparisons) can be used depending, for example, on contract terms between the first entity 152 and the second entity 154. Further, in this example, the first, second, and third metadata fields can correspond to a single field of the metadata 120 or the first, second, and third metadata fields can include two or more (e.g., three) distinct fields of the metadata 120. To illustrate, the values of the first, second, and third metadata fields can correspond to a release date indicated by the date 106 of the metadata 120. In this illustrative example, the first rights criterion can be satisfied if the date 106 is earlier than a first date, the second rights criterion can be satisfied if the date 106 is between the first date and a second date, and the third rights criterion can be satisfied if the date 106 is between the second date and a third date. In this illustrative example, the third rights criterion is not satisfied if the date 106 is after the third date.

In the illustrative example above, the IP rights classifier 126 uses heuristic rule(s) 138 based on the fields of the metadata 120. In other implementations, the IP rights classifier 126 uses machine learning data models 140 to evaluate the fields of the metadata 120 to generate classification labels, and the classification labels generated by the machine learning data models 140 are compared to the rights criteria 148 to determine an IP rights label 142 to assign to a particular data file. In such implementations, the machine learning data models 140 can be trained using labeled training data (not shown) to be able to distinguish features of the metadata 120, the data file(s) 122, or both, in order to assign the classification labels. For example, the labeled training data can be generated by a human user. In this example, the human user assigns a set of relevant labels to a set of data files of the data file(s) 122, then uses a machine learning training process to generate a neural network, a decision tree, a support vector machine, or another type of machine learning data models 140 capable of performing classification operations.

In some implementations, the classification labels used to train the machine learning data models 140 correspond to or include candidate IP rights labels 146, in which case a classification label output by the machine learning data models 140 for a particular data file is the IP rights label 142. In other implementations, the classification labels are not identical to and/or do not include the candidate IP rights labels 146, in which case a classification label output by the machine learning data models 140 for a particular data file is another type of metadata 120 and is compared (perhaps with other metadata) to the rights criteria 148 to assign the IP rights label 142.

In still other implementations, the machine learning data models 140 can evaluate the data file(s) 122 to generate at least a portion of the metadata 120. For example, the machine learning data models 140 can be trained to identify parts depicted in a particular engineering drawing and to generate the parts list 110 for the engineering drawing.

Additionally, or in the alternative, in some implementations, the machine learning data models 140 are trained to generate a risk value 144 (or confidence value) indicating an estimate of the likelihood that the IP rights label 142 assigned to a particular data file is correct. In such implementations, the IP rights label 142 can be assigned by the heuristic rule(s) 138 or by the machine learning data models 140. For example, the heuristic rule(s) 138 can be used to assign the IP rights label 142, and the metadata 120, the data file, the IP rights label 142, other information, or a combination thereof, can be provided as input to the machine learning data models 140 to generate the risk value 144. In another example, the machine learning data models 140 can both assign the IP rights label 142 and estimate the risk value 144 based on the metadata 120, the data file, and/or the other information.

The data 150 (e.g., the IP rights label 142, the risk value 144, or both) can be stored in the memory device(s) 114, in the database(s) 118, or both, and used as filter criteria for providing access to the data file(s) 122, for report generation, etc. To illustrate, the computing device(s) 102 can assign to the second entity 154 a first set of permissions (e.g., read and write access) with respect to a first subset of the data files 122 assigned a first IP rights label 142 and can assign a second set of permissions (e.g., read only, or no access) with respect to a second subset of the data files 122 assigned a second IP rights label 142. In another example, a batch of data files 122 can be automatically assembled for communication to the second entity 154 based on the data 150. To illustrate, the second entity 154 can be automatically provided all data files 122 assigned a first IP rights label 142 and can be denied all data files 122 assigned a second IP rights label 142. In this illustrative example, data file(s) 122 assigned a third IP rights label 142 can be set aside for further review to determine whether such data file(s) 122 should be provided to the second entity 154 or not.

The risk value 144 associated with each data file may also be considered when automatically assigning permissions or batching data file(s) 122. To illustrate, the second entity 154 may be automatically provided access to data file(s) 122 that have particular IP rights labels and a low risk value 144 (e.g., indicating confidence greater than a threshold). In this illustrative example, data file(s) 122 that have particular IP rights labels and a high risk value 144 (e.g., indicating confidence below the threshold) may be set aside for user review before the second entity 154 is granted access. Thus, one technical effect of the system 100 is to improve the reliability of and simplicity of access control to the data file(s) 122.

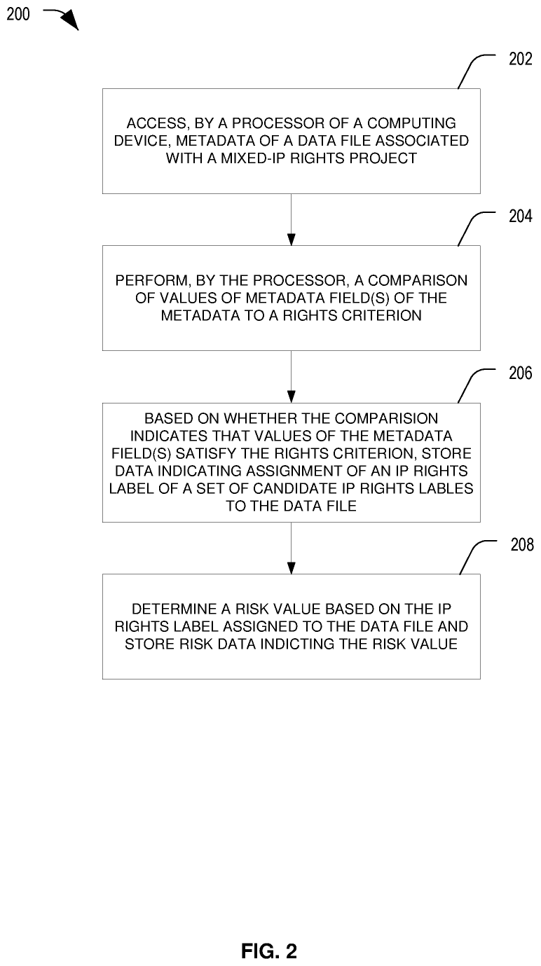

FIG. 2 is a flow chart illustrating an example of a method 200 for assigning an IP rights label. In particular implementations, the method 200 is initiated, controlled, or performed by the system 100. For example, the processor(s) 112 can execute the instructions 124 to initiate, control, or perform various operations of the method 200.

At block 202, the method 200 includes accessing, by a processor of a computing device, metadata of a data file associated with a mixed-IP rights project. For example, the processor(s) 112 of the computing device(s) 102 can access the metadata 120, the data file(s) 122, or both, from the database(s) 118. When the metadata 120 is stored in more than one data table, the processor(s) 112 can perform table operations to consolidate or otherwise prepare the metadata 120 for evaluation. To illustrate, accessing the metadata 120 may include performing a join operation to aggregate data related to the data file(s) 122 from a plurality of data tables. In some implementations, the processor(s) 112 can execute the machine learning data models 140 to generate at least a portion of the metadata 120, which portion is subsequently accessed by the IP rights classifier 126.

At block 204, the method 200 includes performing, by the processor, a comparison of values of metadata field(s) of the metadata to a rights criterion. For example, the processor(s) 112 execute the instructions 124 associated with the IP rights classifier 126 to compare the values of the metadata fields to one or more of the rights criteria 148. In some implementations, the IP rights classifier 126 performs more than one comparison. To illustrate, the IP rights classifier 126 can compare a value of a first metadata field to a first of the rights criteria 148 and compare values of other metadata fields to others of the rights criteria 148.

At block 206, the method 200 includes, based on whether the comparison indicates that values of the one or more metadata fields satisfy the rights criterion, storing data indicating assignment of an IP rights label of a set of candidate IP rights labels to the data file. For example, the IP rights classifier 126 stores the IP rights label 142 as a data element of the data 150. The IP rights label 142 is one of the candidate IP rights labels 146. The data 150 is stored in the memory device(s) 114, in the database(s) 118, or both.

In some implementations, the method 200 also includes, at block 208, determining a risk value based on the IP rights label assigned to the data file and storing risk data indicating the risk value. For example, the IP rights classifier 126 can determine the risk value 144 based on the IP rights label 142 assigned to the data file, based on a confidence value associated with the IP rights label 142, etc. In this example, the risk value 144 can be stored as a data element of the data 150.

Thus, the method 200 facilitates labeling the data file(s) 122 with IP rights labels, which improves data access control and security, and reduces the computing time and resources used to comply with contractual obligations.

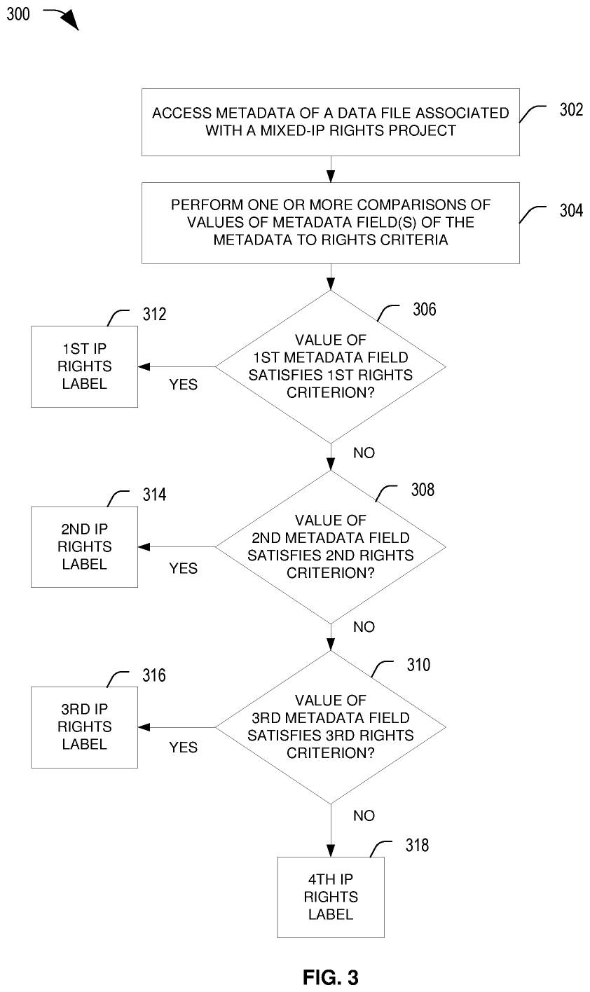

FIG. 3 illustrates a flow chart of another example of a method 300 for assigning an IP rights label. The method 300 includes additional detail of a particular example in which multiple comparisons are performed to assign one of a set of candidate IP rights labels. In particular implementations, the method 300 is initiated, controlled, or performed by the system 100. For example, the processor(s) 112 can execute the instructions 124 to initiate, control, or perform various operations of the method 300.

At block 302, the method 300 includes accessing, by a processor of a computing device, metadata of a data file associated with a mixed-IP rights project. For example, the processor(s) 112 of the computing device(s) 102 can access the metadata 120, the data file(s) 122, or both, from the database(s) 118.

At block 304, the method 300 includes performing, by the processor, a comparison of values of metadata field(s) of the metadata to rights criteria. For example, the processor(s) 112 execute the instructions 124 associated with the IP rights classifier 126 to compare the values of the metadata fields to one or more of the rights criteria 148. In FIG. 3, the method 300 includes, at decision block 306, determining whether a value of a first metadata field satisfies a first rights criterion. In this context, whether a value of a metadata field satisfies a rights criterion depends on the data type of the metadata field. For example, each metadata field can store text, a number, or a logical value. When a metadata field stores text, the value of the metadata field may satisfy the rights criterion when the text of the metadata field matches specified text, when a subset of the text of the metadata field matches specified text, when the text of the metadata field matches a subset of specified text, when the text of the metadata field fits a specified pattern, or a combination thereof. When the metadata field stores a number, the value of the metadata field may satisfy the rights criterion when the number of the metadata field is greater than, is less than, is greater than or equal to, is less than or equal to, or is equal to a specified value, or is between two specified values. When the metadata field stores a logical value, the value of the metadata field may satisfy the rights criterion when the logical value is TRUE, when the logical value is FALSE, when the logical value is defined, or when the logical value is undefined.

If the value of the first metadata field satisfies the first rights criterion, the method 300 includes, at block 312, assigning a first IP rights label to the data file associated with the metadata. If the value of the first metadata field fails to satisfy the first rights criterion, the method 300 advances to decision block 308. At the decision block 308, the method 300 includes determining whether a value of a second metadata field satisfies a second rights criterion. In a particular implementation, the second metadata field is the same as the first metadata field. For example, if the first metadata field stores text, the first rights criterion can be satisfied if the first metadata field includes a first set of text, and the second rights criterion can be satisfied if the first metadata field includes a different set of text. In another example, if the first metadata field stores a number, the first rights criterion can be satisfied if the number in the first metadata field is greater than a first threshold value, and the second rights criterion can be satisfied if the number in the first metadata field is less than the first threshold value and greater than a second threshold value. In other implementations, the second metadata field is distinct from the first metadata field.

If the value of the second metadata field satisfies the second rights criterion, the method 300 includes, at block 314, assigning a second IP rights label to the data file. If the value of the second metadata field fails to satisfy the second rights criterion, the method 300 advances to decision block 310. At the decision block 310, the method 300 includes determining whether a value of a third metadata field satisfies a third rights criterion. In some implementations, the third metadata field is the same as the first metadata field, the same as the second metadata field, or both. In other implementations, the third metadata field is distinct from the first metadata field and distinct from the second metadata field.

If the value of the third metadata field satisfies the third rights criterion, the method 300 includes, at block 316, assigning a third IP rights label to the data file. If the value of the third metadata field fails to satisfy the third rights criterion, the method 300 includes, at block 318, assigning a fourth IP rights label to the data file.

Although the method 300 in FIG. 3 includes three decision steps, in other implementations, the method 300 includes more than three decision steps or fewer than three decision steps. For example, if the set of candidate IP rights labels 146 includes more than four IP rights labels, the method 300 can include more than three decision steps. As another example, one or more of the candidate IP rights labels 146 may be assigned based on two or more comparisons being satisfied, in which case the method 300 can include additional decision steps.

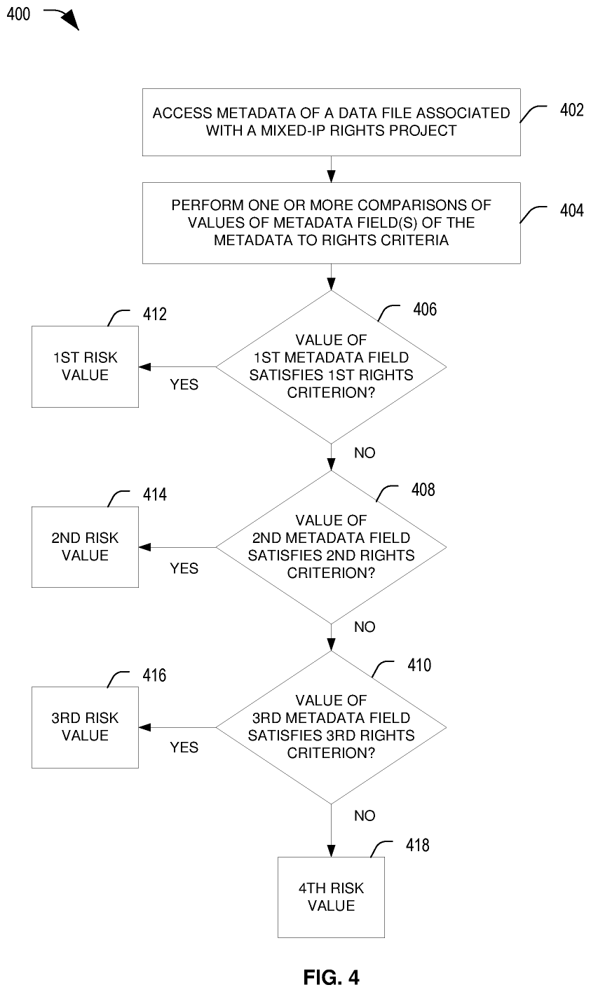

FIG. 4 illustrates a flow chart of an example of a method 400 for determining risk values associated with assignment of IP rights labels. In particular implementations, the method 400 is initiated, controlled, or performed by the system 100. For example, the processor(s) 112 can execute the instructions 124 to initiate, control, or perform various operations of the method 400.

At block 402, the method 400 includes accessing, by a processor of a computing device, metadata of a data file associated with a mixed-IP rights project. For example, the processor(s) 112 of the computing device(s) 102 can access the metadata 120, the data file(s) 122, or both, from the database(s) 118. At block 404, the method 400 includes performing, by the processor, one or more comparisons of values of metadata field(s) of the metadata to rights criteria. For example, the processor(s) 112 execute the instructions 124 associated with the IP rights classifier 126 to compare the values of the metadata fields to one or more of the rights criteria 148.

In FIG. 4, the method 400 includes, at decision block 406, determining whether a value of a first metadata field satisfies a first rights criterion. If the value of the first metadata field satisfies the first rights criterion, the method 400 includes, at block 412, assigning a first risk value to the data file or to the IP rights label assigned to the data file. If the value of the first metadata field fails to satisfy the first rights criterion, the method 400 advances to decision block 408. At the decision block 408, the method 400 includes determining whether a value of a second metadata field satisfies a second rights criterion. In a particular implementation, the second metadata field is the same as the first metadata field. In other implementations, the second metadata field is distinct from the first metadata field.

If the value of the second metadata field satisfies the second rights criterion, the method 400 includes, at block 414, assigning a second risk value to the data file or to the IP rights label assigned to the data file. If the value of the second metadata field fails to satisfy the second rights criterion, the method 400 advances to decision block 410. At the decision block 410, the method 400 includes determining whether a third metadata field satisfies a third rights criterion. In some implementations, the third metadata field is the same as the first metadata field, the same as the second metadata field, or both. In other implementations, the third metadata field is distinct from the first metadata field and distinct from the second metadata field.

If the value of the third metadata field satisfies the third rights criterion, the method 400 includes, at block 416, assigning a third risk value to the data file or to the IP rights label assigned to the data file. If the value of the third metadata field fails to satisfy the third rights criterion, the method 400 includes, at block 418, assigning a fourth risk value to the data file or to the IP rights label assigned to the data file.

Although the method 400 in FIG. 4 includes three decision steps, in other implementations, the method 400 includes more than three decision steps or fewer than three decision steps. In some implementation, a risk value assigned by the method 400 is stored as additional metadata 120, which is used by the IP rights classifier 126 to assign an IP rights label to the data file. For example, a first IP rights label of the candidate IP rights labels 146 can be assigned to data files that satisfy specific rights criteria 148 and that are associated with a low risk value, and a second IP rights label of the candidate IP rights labels 146 can be assigned to data files that satisfy the specific rights criteria 148 and that are associated with a higher risk value.

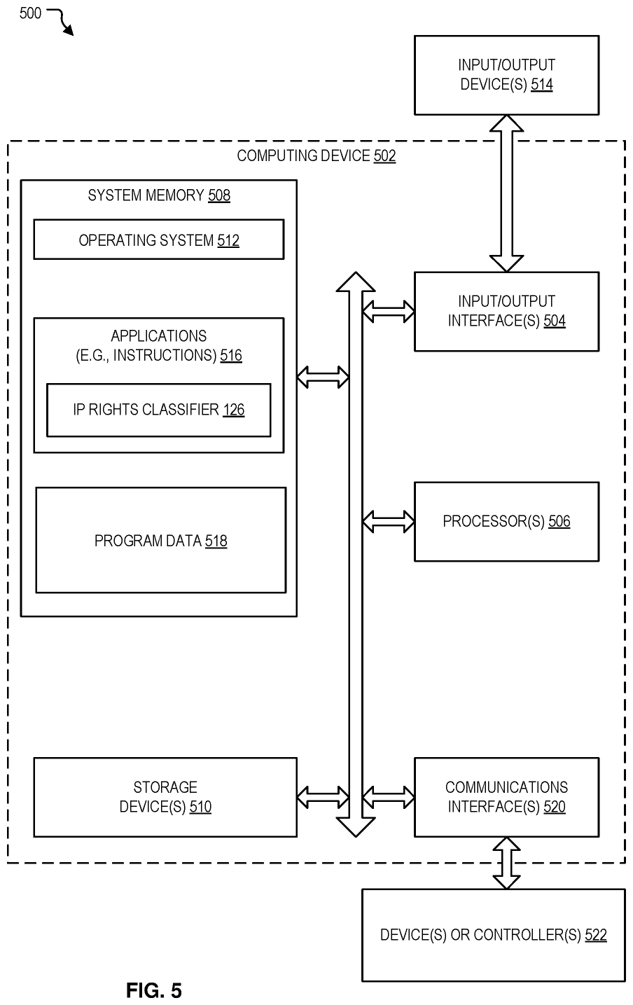

FIG. 5 is a block diagram of a computing environment 500 including a computing device 502 configured to support aspects of computer-implemented methods and computer-executable program instructions (or code) according to the subject disclosure. For example, the computing device 502, or portions thereof, is configured to execute instructions to initiate, perform, or control one or more operations described with reference to FIGS. 1-4. To illustrate, the computing device 502 may include or correspond to one of the computing device(s) 102 of FIG. 1.

The computing device 502 includes one or more processor(s) 506. The processor(s) 506 are configured to communicate with system memory 508, one or more storage devices 510, one or more input/output interfaces 504, one or more communications interfaces 520, or any combination thereof. The system memory 508 includes volatile memory devices (e.g., random access memory (RAM) devices), nonvolatile memory devices (e.g., read-only memory (ROM) devices, programmable read-only memory, or flash memory), or both. The system memory 508 stores an operating system 512, which may include a basic input/output system for booting the computing device 502 as well as a full operating system to enable the computing device 502 to interact with users, other programs, and other devices. The system memory 508 stores program data 518, such as the rights criteria 148, the candidate IP rights labels 146, the data file(s) 122, the metadata 120, the data 150, or portions thereof.

The system memory 508 includes one or more applications 516 (e.g., sets of instructions) executable by the processor(s) 506. As an example, the one or more applications 516 include instructions executable by the processor(s) 506 to initiate, control, or perform one or more operations described with reference to FIGS. 1-4. To illustrate, the one or more applications 516 include instructions executable by the processor(s) 506 to initiate, control, or perform one or more operations described with reference to the IP rights classifier 126 of FIG. 1.

The storage device(s) 510 include nonvolatile storage devices, such as magnetic disks, optical disks, or flash memory devices. In a particular example, the storage device(s) 510 include both removable and non-removable memory devices. The storage device(s) 510 are configured to store an operating system, images of operating systems, applications (e.g., one or more of the applications 516), and program data (e.g., the program data 518). In a particular aspect, the system memory 508, the storage device(s) 510, or both, include tangible computer-readable media. In a particular aspect, one or more of the storage device(s) 510 are external to the computing device 502.

The input/output interface(s) 504 enable the computing device 502 to communicate with one or more input/output devices 514 to facilitate user interaction. For example, the input/output interface(s) 504 can include a display interface, an input interface, or both. For example, the input/output interface(s) 504 is adapted to receive input from a user, to receive input from another computing device, or a combination thereof. In some implementations, the input/output interface(s) 504 conforms to one or more standard interface protocols, including serial interfaces (e.g., universal serial bus (USB) interfaces or Institute of Electrical and Electronics Engineers (IEEE) interface standards), parallel interfaces, display adapters, audio adapters, or custom interfaces (“IEEE” is a registered trademark of The Institute of Electrical and Electronics Engineers, Inc. of Piscataway, N.J.). In some implementations, the input/output interface(s) 504 includes one or more user interface devices and displays, including some combination of buttons, keyboards, pointing devices, displays, speakers, microphones, touch screens, and other devices.

The processor(s) 506 are configured to communicate with device(s) or controller(s) 522 via the one or more communications interface(s) 520. For example, the one or more communications interface(s) 520 can include a network interface. The device(s) or controller(s) 522 can include, for example, the database(s) 118 of FIG. 1.

In conjunction with the described systems and methods, an apparatus for assigning IP rights labels to data files associated with a blended-IP rights project is disclosed and includes means for accessing metadata of a data file associated with the blended-IP rights project. In some implementations, the means for accessing the metadata includes or corresponds to the computing device(s) 102, the processor(s) 112, the communication interface(s) 116 of FIG. 1, the processor(s) 506, the communications interface(s) 520, the input/output interface(s) 504 of FIG. 5, one or more other circuits or devices configured to access the metadata 120, or a combination thereof.

The apparatus also includes means for performing a comparison of values of metadata field(s) of the metadata to a rights criterion. In some implementations, the means for performing the comparison includes or corresponds to the computing device(s) 102, the processor(s) 112 of FIG. 1, the computing device 502, the processor(s) 506 of FIG. 5, one or more other devices configured to perform a comparison, or a combination thereof.

The apparatus also includes means for storing, based on whether the comparison indicates that values of the one or more metadata fields satisfy the rights criterion, data indicating assignment of an IP rights label of a set of candidate IP rights labels to the data file. In some implementations, the means for storing the data includes or corresponds to the computing device(s) 102, the processor(s) 112 of FIG. 1, the computing device 502, the processor(s) 506 of FIG. 5, one or more other devices configured to perform a comparison, or a combination thereof.

In some implementations, a non-transitory, computer readable medium stores instructions that, when executed by processor(s), cause the processor(s) to initiate, perform, or control operations to perform part or all of the functionality described above. For example, the instructions may be executable to implement one or more of the operations or methods of FIGS. 1-4. In a particular implementation, the non-transitory, computer-readable medium corresponds to a computer-readable storage device storing instructions that are executable by one or more processors to perform operations including accessing a data file associated with design or analysis of an engineering project in which entities potentially have intellectual property (IP) rights; evaluating one or more metadata fields of metadata of the data file based on rights selection criteria; selecting, based on the rights selection criteria, an IP rights label of a candidate IP rights labels to be assigned to the data file; and storing data indicating assignment of the IP rights label to the data file.

In some implementations, part or all of one or more of the operations or methods of FIGS. 2-4 may be implemented by processor(s) (e.g., one or more central processing units (CPUs), one or more graphics processing units (GPUs), one or more digital signal processors (DSPs)) executing instructions, by dedicated hardware circuitry, or any combination thereof.

Various aspects of the disclosure are described below in a set of interrelated clauses:

According to Clause 1, a method comprises: accessing, by a processor of a computing device, metadata of a data file associated with a mixed-IP rights project; performing, by the processor, a comparison of values of one or more metadata field(s) of the metadata to a rights criterion; and based on whether the comparison indicates that values of the one or more metadata fields satisfy the rights criterion, storing data indicating assignment of an IP rights label of a set of candidate IP rights labels to the data file.

Clause 2 includes the method of Clause 1 wherein the mixed-IP rights project corresponds to designing a modified system by adapting at least a portion of a base system, wherein a first entity has IP rights to the base system, and wherein a second entity has IP rights to at least a portion of the modified system.

Clause 3 includes the method of Clause 2 wherein the base system corresponds to a commercial aircraft and the modified system corresponds to a military platform based on the commercial aircraft.

Clause 4 includes the method of any of Clauses 1-3 wherein responsive to the comparison indicating that the values of the one or more metadata fields satisfy the rights criterion, the data indicates that a first IP rights label of the candidate IP rights labels is assigned to the data file, wherein the rights criterion is satisfied when the values of the metadata field(s) indicate that the data file pertains to a base system without modifications associated with the mixed-IP rights project and the first IP rights label indicates single-party IP rights.

Clause 5 includes the method of any of Clauses 1-4 wherein the comparison is a first comparison, the one or more metadata fields are a first metadata field, the rights criterion is a first rights criterion, wherein the method further includes responsive to the first comparison indicating that a value of the first metadata field fails to satisfy the first rights criterion, performing a second comparison of a value of a second metadata field of the metadata to a second rights criterion, and wherein the IP rights label is assigned to the data file based on whether the second comparison indicates that the value of the second metadata field satisfies the second rights criterion.

Clause 6 includes the method of Clause 5 and further comprises, responsive to the second comparison indicating that the value of the second metadata field fails to satisfy the second rights criterion, performing a third comparison of a value of a third metadata field of the metadata to a third rights criterion, wherein the IP rights label is assigned to the data file based on whether the third comparison indicates that the value of the third metadata field satisfies the third rights criterion.

Clause 7 includes the method of Clause 6 wherein responsive to the third comparison indicating that the value of the third metadata field satisfies the third rights criterion, the IP rights label assigned to the data file is a third IP rights label of the candidate IP rights labels.

Clause 8 includes the method of Clause 6 wherein responsive to the third comparison indicating that the value of the third metadata field fails to satisfy the third rights criterion, the IP rights label assigned to the data file is a fourth IP rights label of the candidate IP rights labels.

Clause 9 includes the method of any of Clauses 1-8 wherein the data file comprises or corresponds to an engineering drawing.

Clause 10 includes the method of any of Clauses 1-9 wherein the metadata comprises one or more of an identifier of a person or group that released the data file, a release date of the data file, a descriptor of the data file, or a parts list associated with the data file.

Clause 11 includes the method of any of Clauses 1-10 wherein the accessing the metadata comprises performing a join operation to aggregate data related to the data file from multiple data tables.

Clause 12 includes the method of any of Clauses 1-11 and further comprises determining a risk value based on the IP rights label assigned to the data file and storing risk data indicating the risk value.

According to Clause 13, a system comprises one or more processors; and one or more memory devices storing instructions that are executable by the processor(s) to perform operations comprising: accessing, by an IP rights classifier, metadata of an engineering design or analysis data file associated with a blended-IP rights project; selecting, by the IP rights classifier based on the metadata, an IP rights label of a set of candidate IP rights labels to assign to the engineering design or analysis data file; and storing, at the one or more memory devices, data indicating assignment of the IP rights label to the engineering design or analysis data file.

Clause 14 includes the system of Clause 13 and further comprises one or more communication interfaces coupled to the processor(s), wherein the communication interface(s) are configured to enable the processor(s) to communicate with database(s) associated with the blended-IP rights project to access the engineering design or analysis data file and the metadata.

Clause 15 includes the system of Clause 14 wherein the IP rights classifier uses heuristic rule(s), machine learning data model(s), or a combination thereof, to select the IP rights label.

According to Clause 16, a computer-readable storage device stores instructions that are executable by processor(s) to perform operations comprising: accessing a data file associated with design or analysis of an engineering project in which multiple entities potentially have IP rights; evaluating metadata field(s) of metadata of the data file based on rights selection criteria; selecting, based on the rights selection criteria, an IP rights label of a set of candidate IP rights labels to be assigned to the data file; and storing data indicating assignment of the IP rights label to the data file.

Clause 17 includes the computer-readable storage device of Clause 16 wherein the data file includes or corresponds to an engineering drawing associated with the engineering project.

Clause 18 includes the computer-readable storage device of Clause 16 or Clause 17 wherein the engineering project corresponds to designing a modified system by adapting at least a portion of a base system, wherein a first entity of the entities has IP rights to the base system, and wherein a second entity of the entities has IP rights to at least a portion of the modified system.

Clause 19 includes the computer-readable storage device of any of Clauses 16 to 18 wherein the metadata includes one or more of an identifier of a person or group that performed the design or analysis of the engineering project, a date associated with the design or analysis of the engineering project, a descriptor of the design or analysis of the engineering project, or a parts list associated with the design or analysis of the engineering project.

Clause 20 includes the computer-readable storage device of any of Clauses 16 to 19 wherein the operations further comprise determining, based on the metadata, a risk value associated with assignment of the IP rights label to the data file and storing risk data indicating the risk value.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate but do not limit the disclosure. It should also be understood that numerous modifications and variations are possible in accordance with the principles of the subject disclosure. As the following claims reflect, the claimed subject matter may be directed to less than all of the features of any of the disclosed examples. Accordingly, the scope of the disclosure is defined by the following claims and their equivalents.

What is claimed is:

1. A method comprising:
accessing, by a processor of a computing device, metadata of a data file associated with a mixed-intellectual property (IP) rights project;
performing, by the processor, a comparison of values of one or more metadata fields of the metadata to a rights criterion; and
based on whether the comparison indicates that values of the one or more metadata fields satisfy the rights criterion, storing data indicating assignment of an IP rights label of a set of candidate IP rights labels to the data file.

2. The method of claim 1, wherein the mixed-IP rights project corresponds to designing a modified system by adapting at least a portion of a base system, wherein a first entity has IP rights to the base system, and wherein a second entity has IP rights to at least a portion of the modified system.

3. The method of claim 2, wherein the base system corresponds to a commercial aircraft and the modified system corresponds to a military platform based on the commercial aircraft.

4. The method of claim 1, wherein responsive to the comparison indicating that the values of the one or more metadata fields satisfy the rights criterion, the data indicates that a first IP rights label of the candidate IP rights labels is assigned to the data file, wherein the rights criterion is satisfied when the values of the one or more metadata fields indicate that the data file pertains to a base system without modifications associated with the mixed-IP rights project and the first IP rights label indicates single-party IP rights.

5. The method of claim 1, wherein the comparison is a first comparison, the one or more metadata fields are a first metadata field, and the rights criterion is a first rights criterion, wherein the method further includes:
responsive to the first comparison indicating that a value of the first metadata field fails to satisfy the first rights criterion, performing a second comparison of a value of a second metadata field of the metadata to a second rights criterion; and
wherein the IP rights label is assigned to the data file based on whether the second comparison indicates that the value of the second metadata field satisfies the second rights criterion.

6. The method of claim 5, further comprising:
responsive to the second comparison indicating that the value of the second metadata field fails to satisfy the second rights criterion, performing a third comparison of a value of a third metadata field of the metadata to a third rights criterion, wherein the IP rights label is assigned to the data file based on whether the third comparison indicates that the value of the third metadata field satisfies the third rights criterion.

7. The method of claim 6, wherein responsive to the third comparison indicating that the value of the third metadata field satisfies the third rights criterion, the IP rights label assigned to the data file is a third IP rights label of the candidate IP rights labels.

8. The method of claim 6, wherein responsive to the third comparison indicating that the value of the third metadata field fails to satisfy the third rights criterion, the IP rights label assigned to the data file is a fourth IP rights label of the candidate IP rights labels.

9. The method of claim 1, wherein the data file comprises or corresponds to an engineering drawing.

10. The method of claim 1, wherein the metadata comprises one or more of an identifier of a person or group that released the data file, a release date of the data file, a descriptor of the data file, or a parts list associated with the data file.

11. The method of claim 1, wherein the accessing the metadata comprises performing a join operation to aggregate data related to the data file from data tables.

12. The method of claim 1, further comprising determining a risk value based on the IP rights label assigned to the data file and storing risk data indicating the risk value.

13. A system comprising:
one or more processors; and
one or more memory devices storing instructions that are executable by the one or more processors to perform operations comprising:
accessing, by an intellectual property (IP) rights classifier, metadata of an engineering design or analysis data file associated with a blended-IP rights project;
selecting, by the IP rights classifier based on the metadata, an IP rights label of a set of candidate IP rights labels to assign to the engineering design or analysis data file; and
storing, at the one or more memory devices, data indicating assignment of the IP rights label assigned to the engineering design or analysis data file.

14. The system of claim 13, further comprising one or more communication interfaces coupled to the one or more processors, the one or more communication interfaces configured to enable the one or more processors to communicate with one or more databases associated with the blended-IP rights project to access the engineering design or analysis data file and the metadata.

15. The system of claim 14, wherein the IP rights classifier uses one or more heuristic rules, one or more machine learning data models, or a combination thereof, to select the IP rights label.

16. A computer-readable storage device storing instructions that are executable by one or more processors to perform operations comprising:
accessing a data file associated with design or analysis of an engineering project in which multiple entities potentially have intellectual property (IP) rights;
evaluating one or more metadata fields of metadata of the data file based on rights selection criteria;
selecting, based on the rights selection criteria, an IP rights label of a set of candidate IP rights labels to be assigned to the data file; and
storing data indicating assignment of the IP rights label to the data file.

17. The computer-readable storage device of claim 16, wherein the data file includes or corresponds to an engineering drawing associated with the engineering project.

18. The computer-readable storage device of claim 16, wherein the engineering project corresponds to designing a modified system by adapting at least a portion of a base system, wherein a first entity of the entities has IP rights to the base system, and wherein a second entity of the entities has IP rights to at least a portion of the modified system.

19. The computer-readable storage device of claim 16, wherein the metadata includes one or more of an identifier of a person or group that performed the design or analysis of the engineering project, a date associated with the design or analysis of the engineering project, a descriptor of the design or analysis of the engineering project, or a parts list associated with the design or analysis of the engineering project.

20. The computer-readable storage device of claim 16, wherein the operations further comprise determining, based on the metadata, a risk value associated with assignment of the IP rights label to the data file and storing risk data indicating the risk value.
